(19) United States
(12) Patent Application Publication
(10) Pub. No.: US 2008/0067212 A1
(43) Pub. Date: Mar. 20, 2008

(54) Magazine for Nail Gun

(76) Inventor: Wan-Fu Wen, Taipei Hsien (TW)

Correspondence Address: HDSL, 4331 STEVENS BATTLE LANE, FAIRFAX, VA, 22033, US

(21) Appl. No.: 11/532,015

(22) Filed: Sep. 14, 2006

(51) Int. Cl. B25C 5/06

(52) U.S. Cl. 227/120

(57) ABSTRACT

A magazine has a nail groove for receiving nails and a nail gate being inserted into the nail groove or being disposed at one end of the nail groove. The nail gate has an elastic piece, a stopping plate extending from the elastic piece, and a tongue extending from the elastic piece. The nail gate opens when the nail firstly touches the tongue, and the nail gate closes when the nail firstly touches the stopping plate.

### BACKGROUND

The present invention relates to a magazine for supplying connected nails of two or more different-length, and particularly to a magazine having a nail gate that prevents different length nail from being erroneously mounted into the magazine groove.

Magazine is generally provided in a nail gun or palm nailer for containing nails therein. The magazine has a magazine body for receiving the nail rows and utilizes an elastic deformation force of a spring to drive each nail to a nail driving mechanism, which is connected with a drive portion. The drive portion can generate a force for driving nails in the nail driving mechanism into a work piece.

As shown in FIG. 1a, the magazine has a nail groove 10 for storing a plurality of nails, which the nails are supported by a connection band, in a plane-shaped group of connected nails. The magazine contains two different-length nails, a longer nails 2 and a short nails 3. Each nail 2, 3 includes a nail head 2a, 3a and a nail shaft 2b, 3b, the nail head 2a, 3a being larger than the nail shaft 2b, 3b, respectively. The nail groove 11 has a shape substantially same to that of the nails, which has an upper guide rails 11a, a lower guide rails 11b and a nail shaft passage 11c engaging with each other. The upper and lower guide rails 11a, 11b guide the nail head 2a, 3a of the longer and short nails 2, 3, respectively. The nail shaft passage 11c supports the longer and short nails 2, 3 so that the nail shafts 2b, 3b are aligned in a shaft direction.

However, the nail shaft passage 11c is a single passage, which guides the nail shafts 2b, 3b. That is the nail shaft passage 11c has a longer length than that of the nail shaft 3b of the short nails 3. In addition, the size of the nail head 3a matches with that of the upper guide rails 11a. Thus, it is possible for an operator to erroneously load the short nails 3 in the upper guide rails 11a, which makes the short nails 3 to be positioned at an error location and influences the hitting of the short nails 3.

Accordingly, what is needed is a magazine for nail gun that can overcome the above-described deficiencies.

### BRIEF SUMMARY

A magazine for nail gun has a nail groove for receiving nails and a nail gate being inserted into the nail groove or being disposed at one end of the nail groove. The nail gate has an elastic piece, a stopping plate extending from the elastic piece, and a tongue extending from the elastic piece. The nail gate opens when the nail firstly touches the tongue, and the nail gate closes when the nail firstly touches the stopping plate.

The magazine for nail gun utilizes a nail gate disposed in an nail groove or at one end of the nail groove to avoid two different length nails being erroneously mounted into the nail groove.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1a and FIG. 1b are schematic, cross sectional view of a conventional magazine, which shows a nail groove;

FIG. 2 is a schematic, perspective view of a nail gate of a magazine according to a first embodiment of the present invention;

FIG. 3 shows an assembly view of the nail gate of FIG. 2 in a nail groove of the magazine, the nail gate being positioned at one end of the nail groove;

FIG. 4 is a schematic, perspective view showing the nail gate of FIG. 2 cooperating with a rear base of the magazine;

FIG. 5 a schematic, a cross-sectional view the rear base of FIG. 4, which shows the nail gate inserting into a nail shaft passage of the nail groove;

FIG. 6 a schematic, a cross-sectional view the rear base according an alternative modification, which shows the nail gate inserting into an upper nail head rail and a nail shaft passage of the nail groove;

FIG. 7 shows a first assembly state of assembling longer nails in the nail groove;

FIG. 8 is a top view of FIG. 7, showing an assembly state of assembling a beginning longer nail into the nail groove;

FIG. 9 is a side view of FIG. 7, showing an assembly state of pushing the nail gate out of the nail groove;

FIG. 10 shows a second assembly state of assembling short nails in the nail groove;

FIG. 11 is a top view of FIG. 10, showing an assembly state of assembling a beginning short nail into the nail groove;

FIG. 12 is a side view of FIG. 10, showing an assembly state of pushing the nail gate out of the nail groove;

FIG. 13 shows a third assembly state of assembling short nails in an error position of the nail groove;

FIG. 14 is a top view of FIG. 13, showing an assembly state of assembling a beginning short nail into the nail groove;

FIG. 15 is a side view of FIG. 13, showing an assembly state of the nail gate in the nail groove, which can not be pushed out; and

FIG. 16a, FIG. 16b, FIG. 16c respectively show assembly states of the longer nail in a right position of the nail groove, and the short nail in a right and an error position of the nail groove.

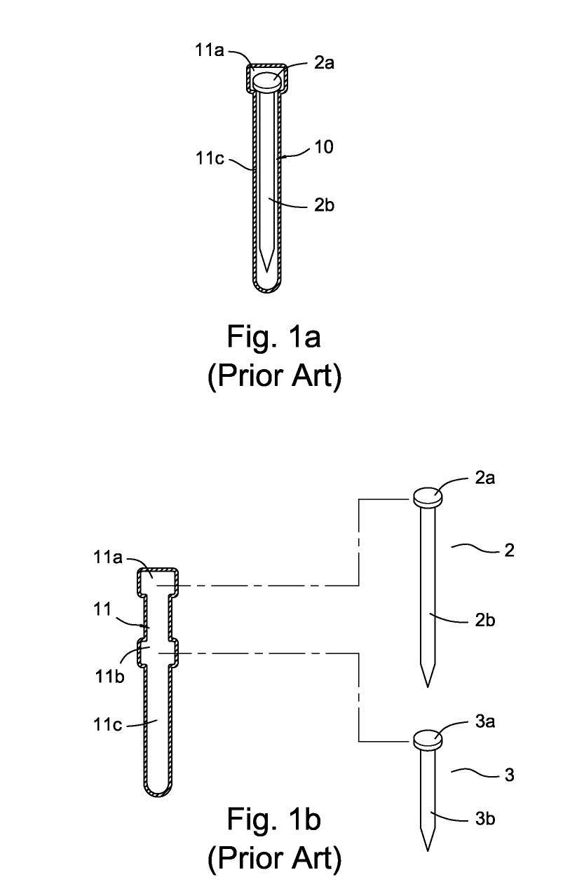

### DETAILED DESCRIPTION

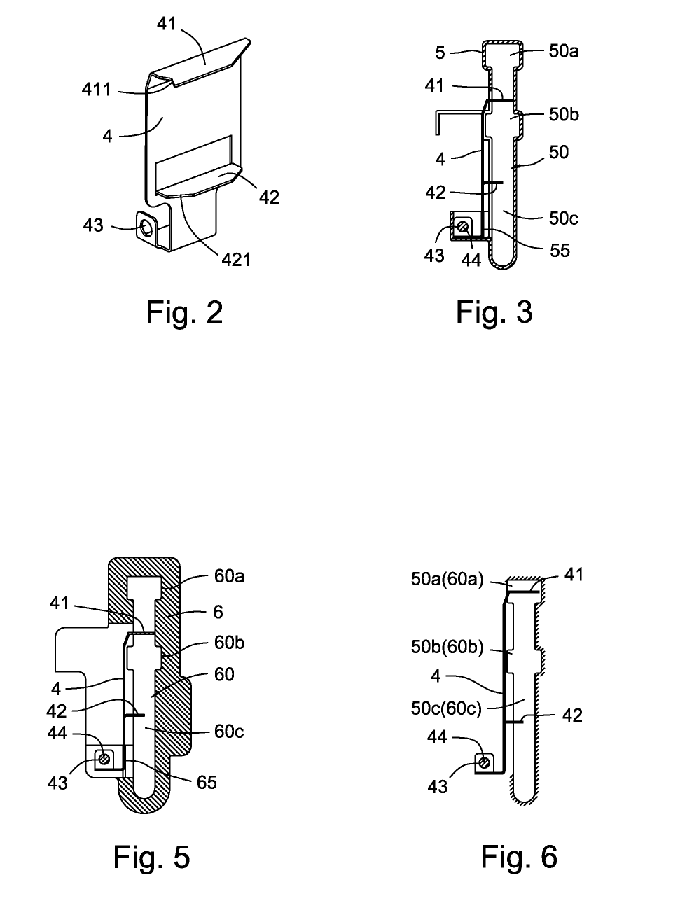

Referring to FIG. 2 and FIG. 3, a magazine 5 has a nail gate 4 and a nail groove 50, which cooperate with each other to prevent the different length nails from being erroneously mounted into the nail groove 50. The nail gate 4 can be inserted into the nail groove 50 or be disposed at one end of the nail groove 50. The nail gate 4 has an elastic piece (not labeled), a stopping plate 41 extending from an upper end of the elastic piece, in a direction of perpendicular to the elastic piece, and a tongue 42 perpendicularly extending from an intermediate portion of the elastic piece, parallel to the stopping plate 41. The stopping plate 41 has a stopper 411 in V-shaped groove. The tongue 42 has a tilted cutout 421.

The nail groove 50 has an upper nail head rail 50a, a lower nail head rail 50b and a nail shaft passage 50c, connecting with each other. The upper and lower nail head rails 50a, 50b guide two nail heads 2a, 3a of a longer and a short nails 2, 3, respectively. The nail shaft passage 50c supports the longer and short nails 2, 3 so that two nail shafts 2b, 3b are aligned in a shaft direction.

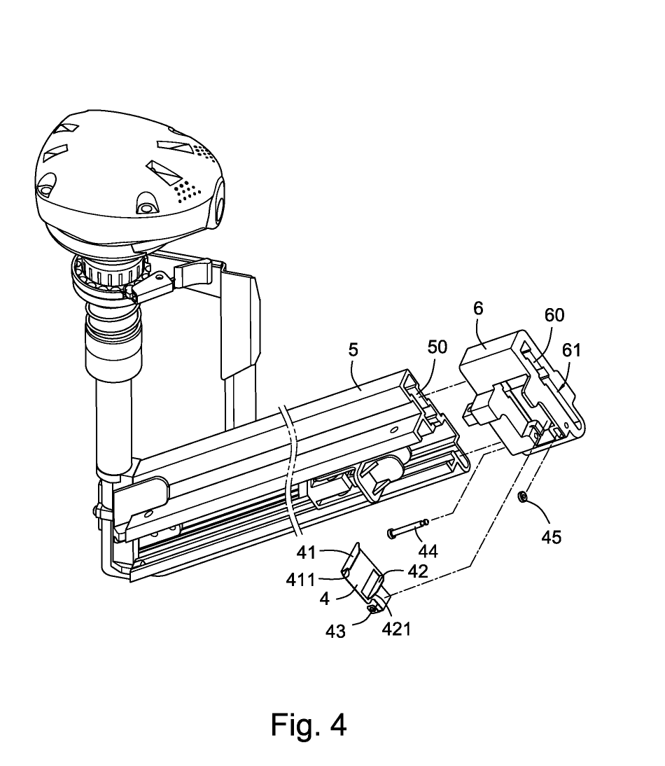

As shown in FIG. 4, the magazine 5 further has a rear base 6, which has a nail groove 60 similar to and connecting with the nail groove 50. The nail gate 4 can be inserted into the nail groove 60 or be disposed at one end of the nail groove 60. In addition, the nail groove 60 has an entrance 61 at one end connecting with the outside, by which the longer and short nails 2, 3 are entered.

In assembly, the nail gate 4 is disposed on one end of the nail groove 50 (60) by a pivot 44 drilling through an ear hole 42 of the nail gate 4 and one locating hole (not labeled) on the nail groove 50 (60). The pivot 44 fixes the nail gate 4 thereon by cooperating with a fixing ring 45. In addition, the elastic piece of the nail gate 4 is inserted into an embedded groove 55 (65) of the nail groove 50 (60), which the embedded groove 55 (65) is formed at one end of the nail groove 50 (60). Moreover, the stopping plate 41 and the tongue 42 of the nail gate 4 are respectively inserted into the nail shaft passages 50c (60c) of the nail groove 50 (60). In an alternative modification, the stopping plate 41 of the nail gate 4 is inserted into the upper nail head rail 50a (60a) of the nail groove 50 (60), and the tongue 42 of the nail gate 4 is inserted into the nail shaft passage 50c (60c) of the nail groove 50 (60).

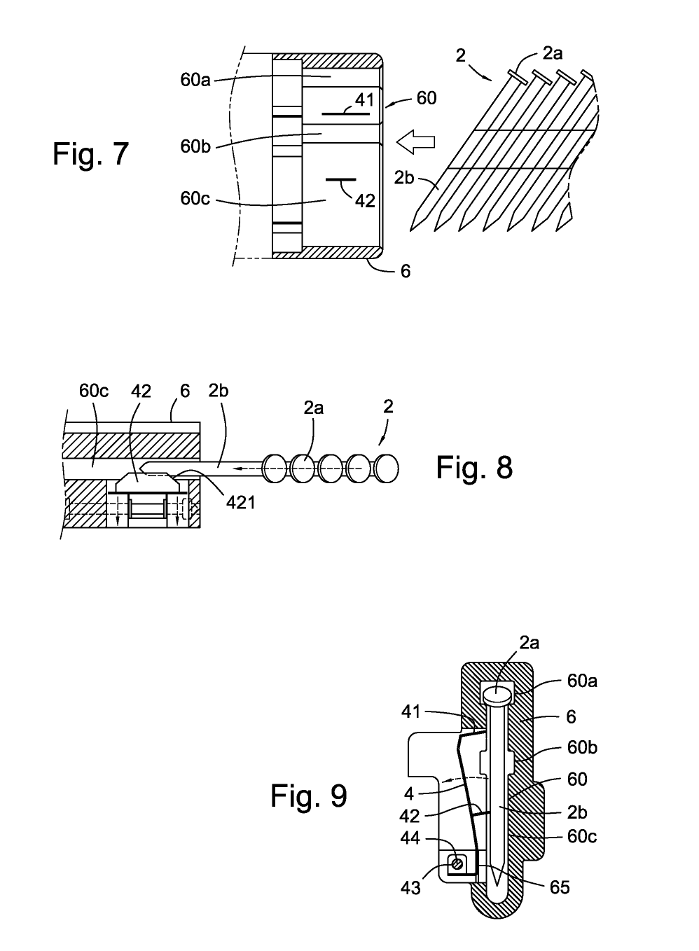

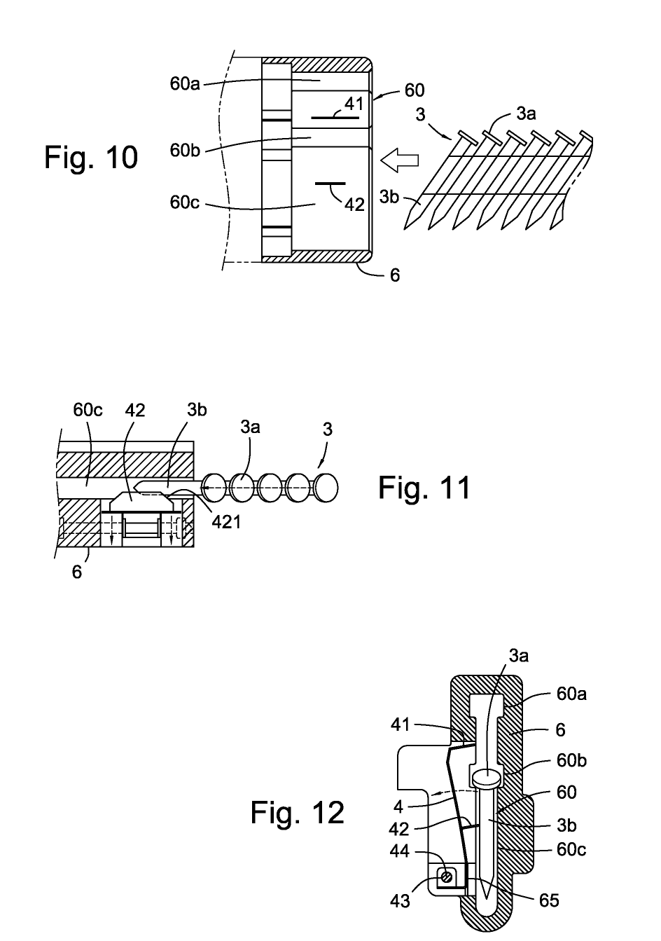

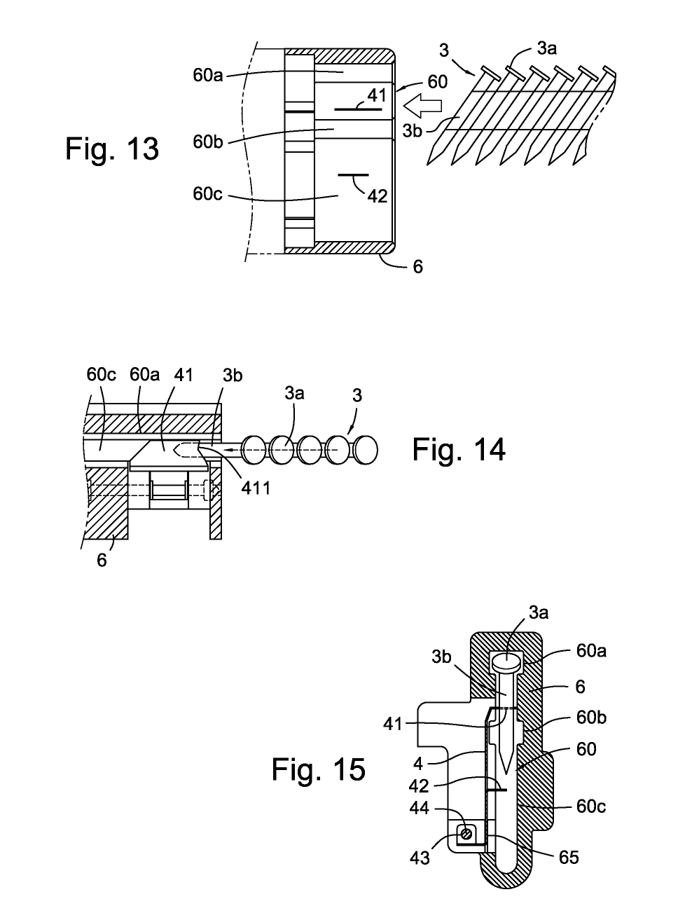

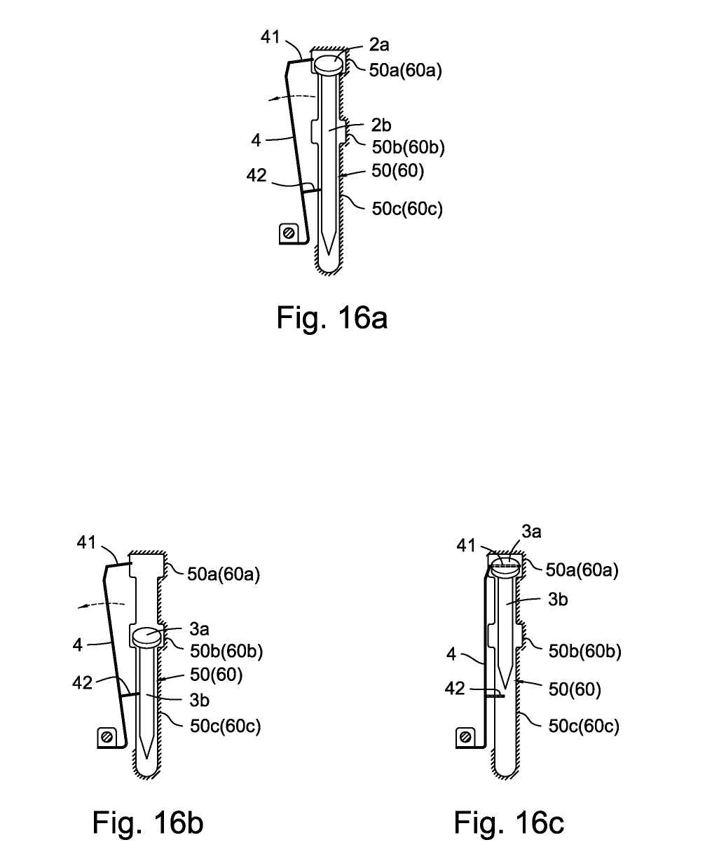

In assembly, assuming the nail gate 4 is disposed in the nail groove 60 of the rear base 6, the following specification will describe the different states of assembling two different length nails 2, 3 in different position. Firstly, when an operator assembles longer nails 2 (as shown in FIG. 7) into the nail groove 60 maintaining a tilted angle between the longer nails 2 and the nail groove 60, the beginning longer nail 2 firstly touches and pushes the titled portion 421 of the tongue 42 of the nail gate 4 (as shown in FIG. 8). That is the thrust of beginning longer nail 2 makes the elastic piece of the nail gate 4 to produce an elastic deformation or swing, and be out of the nail groove 60 (as shown in FIG. 9). Thus, the nail groove 60 is opened and allows the nail head 2a and the nail shaft 2b respectively to enter into the upper nail head rail 60a and the nail shaft passage 60c. Secondly, when an operator assembles short nails 3 (as shown in FIG. 10) into the nail groove 60, corresponding to the lower nail head rail 60b, the titled beginning short nail 3 firstly touches and pushes the titled portion 421 of the tongue 42 of the nail gate 4 (as shown in FIG. 11). That is the thrust of beginning short nail 3 makes the elastic piece of the nail gate 4 to produce an elastic deformation or swing, and be out of the nail groove 60 (as shown in FIG. 12). Thus, the nail groove 60 is opened and allows the nail head 3a and the nail shaft 3b respectively to enter into the lower nail head rail 60b and the nail shaft passage 60c. Thirdly, when an operator assembles short nails 3 (as shown in FIG. 13) into the nail groove 60, corresponding to the upper nail head rail 60a, the titled beginning short nail 3 firstly touches and pushes the stopper 411 of the stopping plate 41 of the nail gate 4 (as shown in FIG. 14). The stopper 411 stops the beginning short nail 3 in its V-shaped groove. Thus, the nail gate 4 can not produce an elastic deformation and prevents the nail head 3a and the nail shaft 3b of the short nail 3 into the corresponding upper nail head rail 60a and the nail shaft passage 60c. Therefore, the nail gate 4 avoids the short nail 3 being erroneously mounted into the nail groove 60.

In another alternative modification, the stopping plate 41 of the nail gate 4 is inserted into the upper nail head rail 50a (60a) of the nail groove 50 (60), and the tongue 42 of the nail gate 4 is inserted into the nail shaft passage 50c (60c) of the nail groove 50 (60) (as shown in FIG. 6). The tongue 42 can still open the nail groove 50 (60) by a thrust of the beginning longer or short nail 2, 3 and allows the nails 2, 3 to be assembled into the nail groove 50 (60). The stopping plate 41 still can stop the short nail 3 erroneously mounted into the nail groove 50 (60).

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

1-20. (canceled)

21. A magazine comprising:
a nail groove for receiving nails, including an upper nail head rail, a lower nail head rail and a nail shaft passage, the upper and the lower nail head rails receiving nail heads of a longer and a short nails, respectively, and the nail shaft passage receiving nail shafts of the longer and short nails; and
a nail gate fixedly disposed beside the nail groove, comprising an elastic piece, a stopping plate protruding out from an upper end of the elastic piece, perpendicularly to the elastic piece, so as to insert into the upper nail head rail or insert into the nail shaft passage at a first position between the upper and the lower nail head rails, and a tongue protruding out from a lower portion of the elastic piece, parallel to the stopping plate, so as to insert into the nail shaft passage at a second position below the lower nail head rail,
wherein the tongue has a tilted cutout for the nail shafts of the longer and the short nails pushing thereon to deform the elastic piece so that the stopping plate is out of the nail groove if the longer and the short nails have the nail heads correctly received in the upper and the lower nail head rails, respectively, and if the nail head of the short nail is incorrectly received in the upper nail head rail, the nail shaft of the short nail can not push on the tongue so that the short nail is stopped by the stopping plate.

22. The magazine as claimed in claim 21, wherein the nail gate includes an ear hole for a pin drilling therethrough and cooperating with a fixing ring, and the elastic piece is inserted into an embedded groove so that the nail gate is fixedly disposed beside the nail groove.

23. The magazine as claimed in claim 21, wherein the nail groove is formed in a rear base which is attached to one end of a magazine body.
